(19) United States
(12) Patent Application Publication
(10) Pub. No.: US 2007/0088749 A1
(43) Pub. Date: Apr. 19, 2007

(54) Registration based mail-addressing system

(76) Inventors: Yoav Lorch, Ramat Hasharon, CT (US); Gila Oren, Tel Aviv (IL); Brandon Bezzant, Olivette, MO (US); Jonathan Goldstein, University City, MO (US); Steven Fox, Clayton, MO (US)

Correspondence Address: DICKSTEIN SHAPIRO LLP, 1825 EYE STREET NW, Washington, DC, 20006-5403, US

(21) Appl. No.: 11/501,915

(22) Filed: Aug. 10, 2006

Related U.S. Application Data
(63) Continuation of application No. 09/739,959, filed on Dec. 20, 2000, now abandoned.

(51) Int. Cl. G06F 17/00

(52) U.S. Cl. 707/104.1

(57) ABSTRACT

A method, system and product for delivering a postal mailpiece to a recipient address. A registration based mail-addressing protocol is utilized that allows a postal recipient to create and maintain a proxy address, which is dynamically associated with the recipient's postal address and is more simple than the postal address. The sender of a postal mailpiece addresses the mailpiece with the simplified proxy address instead of the burdensome recipient postal address. The method, system and product allows recipients to create and manage proxy addresses, detects a proxy address on a mailpiece and takes the appropriate measures to deliver the postal mailpiece to a physical address corresponding recipient postal address.

### BACKGROUND

This invention relates to postal mailpiece delivery and, in particular, to a registration based mail-addressing system for delivering postal mail to recipient physical addresses.

Referring to FIG. 1, the current postal delivery scheme operates through the correspondence of two levels of addresses: one level consists of the physical address or geographic location, and the second level consists of a postal address 20 that corresponds to the physical address. Thus, the current accepted system of postal addressing requires that a sender utilize a postal address 20 which corresponds specifically to a single physical address or location of the mailpiece's destination.

A physical address or location is typically a domicile or place of business. This term describes the actual destination of a mailpiece 10. A physical address need not be expressed in a prescribed format. Instead it may typically be based on intuitive elements necessary to describe the location to those familiar with an area or able to follow clear directions. Examples include, but are not limited to, “the large glass building at the corner of Main Street & Grove Avenue” or “the second house on the left, just past Warren G. Harding Elementary School.” Additionally, physical addresses might be described by reference to a grid system, for example in latitude and longitude.

Postal addresses 20 are more formalized expressions of location. Postal addresses 20 contain prescribed information in a closely mandated format. There are numerous postal address 20 formats, but for any given format each postal address 20 describes a unique location. When presented as such, a mail handling entity can use the postal address for delivery of a mailpiece 10 to a physical address or location. Not all physical locations have a postal address 20 due to carrier limitation, location remoteness, or failure to be recognized by postal authorities. Examples of postal addresses 20 are listed below in Table I.

TABLE I

| Type of Postal Address | Postal Address Format |
|---|---|
| A. Street Address | 151 E. 51^{ST} ST |
| | Apt. 2B |
| | New York, NY 10022 |
| B. Post Office box address | PO Box 2378 |
| | Burlingame, CA |
| | 94010-2378 |
| C. 11-digit delivery point zip code | 94025-3271 04 |
| D. Corporate post address | CA5-162-13, Dept 4 |

FIG. 1 illustrates a typical postal mailpiece 10. The mailpiece 10 comprises an envelope 12 that is addressed with a sender or return postal address 14 and a recipient postal address 20. Also illustrated is a postage marking 16, which is required for the United States Postal Service (USPS) or other mail handling entity to deliver the mailpiece 10 to the recipient physical address 20. It should be appreciated that the mailpiece 10 is not limited to envelopes and that the mailpiece 10 may be a postcard, flat, periodical, package, box, or any other parcel suitable for delivery. It should also be appreciated that the postage marking 16 is not limited to a stamp and may be a postage meter marking, pre-printed postage marking, franker marking or any other form of postage employed by mail handling entities. It should further be appreciated that mail handling entities may include, but are not limited to public postal systems (e.g. USPS), private postal systems (e.g. FedEx), messenger service, or internal corporate mail systems (e.g. inter/intra office mail).

In the case of a mailpiece sent via the USPS, the recipient postal address 20 must include numerous fields if it is to be delivered to the correct physical address associated with the postal address 20. These fields include recipient name 22, first recipient address line 24 (often referred to as address line 1), second recipient address line 26 (often referred to as address line 2), city 28, state 30 and zip code 32 fields. The illustrated zip code 32 represents the “zip+4” zip code format that facilitates improved automated handling by mail handling entities. It should be noted that if the mailpiece 10 is destined for a corporation, law firm, or other organization, then the recipient address 20 may include fields in addition to those illustrated in FIG. 1. Thus, the sender of the typical mailpiece 10 must correctly transcribe at least six fields of recipient information onto the mailpiece 10 to ensure that the recipient postal address 20 properly identifies the recipient and the recipient's physical address.

The use of the conventional recipient postal address 20 has several disadvantages that may discourage the sender from using postal mail delivery. As can be seen from FIG. 1 and Table I, for postal addresses A and B, the address 20 is lengthy and requires numerous fields 22, 24, 26, 28, 30, 32 that are non-intuitive. Similarly, as seen in FIG. 1 and Table I, for postal address C, the 11-digit zip code postal address is shorter, but consists of a non-intuitive series of 11 numbers. In either case, the recipient's postal address 20 is very difficult for a sender to recall. Often times, the sender must look up the address 20 in a personal address book, public telephone directory, or other source or sources prior to addressing the mailpiece 10. Address lookup is time consuming and makes the postal mailing process inconvenient and aggravating for the sender, which may prevent the sender from using postal mail in the future. Moreover, even when the sender has retrieved the address information, the length of the recipient postal address 20 increases the likelihood that the sender will make an error when transcribing the address 20 on to the mailpiece 10. Thus, there is a desire and need to reduce the length and information required in the recipient postal address 20.

The use of the recipient postal address 20 is also disadvantaged because it is tied to a physical location. Since the recipient postal address 20 includes specific address fields that identify a physical location (e.g., a recipient's home or office), the postal address 20 will change when the intended recipient (or business) changes locations. The expense associated with the address change and the cost of misdirected correspondence can be considerable; particularly when a business moves and the postal address 20 is associated with the changed business address. Thus, it is desirable to eliminate the expenses and confusion associated with a recipient's address change.

Moreover, physical addresses are perpetual. That is, as long as a recipient remains at the same physical address, a sender can always send a mailpiece 10 to the recipient if she knows the correct recipient postal address 20. There may be times when a recipient desires to prevent the delivery of mailpieces to the physical address. Thus, there is a desire and need to prevent future correspondence to an intended recipient without the intended recipient having to move from the physical address.

Moreover, the recipient postal address 20 could be a security or privacy risk if obtained for use by the wrong individual or organization. For example, there are times when a recipient would like to receive a mailpiece 10 at home, but does not want to give out her home address. This may arise, for example, when a recipient responds to an advertisement, catalog, or other notice for the delivery of an item to the recipient's physical home address. The individual may wish to keep her home physical location non-public for several reasons. There are many examples of privacy issues, almost too many to list, but some examples include preventing stalkers, criminals, photographers, news media, and others from gathering at a recipient's home. Unfortunately, using the conventional mailpiece addressing scheme, in order for a sender to send a mailpiece 10 to the recipient's home, the sender must have the recipient's physical home address to apply the recipient postal address 20 to the mailpiece 10. This requires the recipient to disclose her physical location despite the risks associated with doing so. Thus, there is a desire and need for a mailpiece delivery system that allows the mailpiece 10 to be delivered without disclosing the recipient's actual physical location to the sender or general public.

It should be noted that some recipients rent post office box (“P.O. box”) addresses in an attempt to avoid disclosing their actual physical location to a sender. P.O. box addresses, however, must contain at least the first recipient address line 24, city 28, state 30 and zip code 32 fields in order for the mailpiece 10 to be delivered to the correct P.O. box. Therefore, P.O. boxes represent an incomplete solution to the privacy concern, as the sender obtains the recipient's city and state information from the recipient P.O. box address, inhibiting the privacy resulting from the P.O. box's use. In addition, P.O. box addresses are quite lengthy and require the sender to remember several fields 22, 24, 28, 30, 32 of addressing information, thus suffering from the same drawbacks noted above. Further, P.O. box addresses are tied to a physical location, namely a post office or commercial location near the recipient's physical location, thus presenting difficulties in the event of changes of location. Lastly, using a P.O. box creates inconvenience for the mail recipient, forcing the recipient to receive and collect mail from the post office location.

While the a foregoing example identifies limitations of the addressing scheme utilized by most private and public mail handling entities, proprietary addressing schemes used by corporate mail systems suffer from the same limitations of complexity, non-intuitiveness, location dependence and non-privacy.

Moreover, it is a disadvantage of the current postal addressing system that any mail handling instructions such as, e.g., mail forwarding, temporary hold of mailpieces 10, and routing mailpieces 10 between physical locations, is a cumbersome process typically involving the completion, submission and processing of paper-based instructions. An easier and more efficient process for providing and processing detailed mail handling instructions would be useful, for example when a recipient or corporation desires to route mail between many physical locations without the undue burden of filing papers with the mail handling entity or informing the sender of the different physical addresses.

Moreover, it is a disadvantage of the current postal addressing system that it does not permit the recipient to customize or personalize its recipient postal address 20. A customized or personalized postal address 20 could be used to identify the recipient, the recipient's line of business, or other element in a manner that would make it easy to remember the recipient postal address 20. For example, a customized or personalized postal address 20 could be used by a political campaign so party supporters can send mailpieces 10 to a specific party or politician. A customized postal address 20 could similarly be used for marketing, promotions and other situations where mnemonics and/or an intuitive personalized address would aid the sender in originating a postal mailpiece 10.

Moreover, it is a disadvantage of the current postal addressing system that it makes it difficult or impossible to track mail on a recipient basis. The tracking of mail could be useful when implementing a pre-paid postage system or other value-added service. The tracking of mail based on a recipient could also be used to analyze the recipient's mail flow, allowing a recipient to better manage incoming mail.

### SUMMARY

The present invention provides a method, system and article of manufacture for delivering a postal mailpiece. The present invention also provides a method, system and article of manufacture for creating and maintaining proxy addresses for a postal mailpiece. The present invention further provides a method, system and article of manufacture for providing mail management tools such as mail forwarding, temporary hold, and routing between physical locations. The present invention also provides a method, system and article of manufacture for providing mail-based value-added services. The present invention also provides a method, system and article of manufacture for implementing a corporate or business internal mail system.

A first method comprises the steps of detecting a proxy address on the postal mailpiece, using the detected proxy address to obtain a recipient postal address from a list of recipient postal addresses and associated recipient proxy addresses, and delivering the mailpiece to the physical address associated with the obtained recipient postal address. According to the method, proxy addresses and postal addresses contained within the list are defined by postal recipients associated with the proxy addresses.

In another aspect of the invention, another method of delivering a postal mailpiece is provided. The method comprises the steps of detecting a proxy address on the postal mailpiece and using the detected proxy address to obtain a recipient postal address from a database of recipient postal addresses and associated recipient proxy addresses. Postal recipients associated with the addresses define the proxy addresses and corresponding postal addresses, and the relationship between all such addresses within the database. The method also comprises affixing the obtained recipient postal address to the postal mailpiece so that the mailpiece can be delivered to the physical address associated with the so obtained recipient postal address.

In yet another aspect of the invention, a method of identifying a recipient postal address from a postal mailpiece comprising a proxy address is provided. The method comprises the steps of detecting the proxy address on the postal mailpiece and using the detected proxy address to obtain a recipient postal address from a list of recipient postal addresses and associated recipient proxy addresses. Proxy addresses contained within the list are defined by postal recipients associated with the proxy addresses.

In a further aspect of the invention, a method of managing a delivery of a mailpiece is provided. The method comprises the steps of inputting a proxy address, inputting mail handling instructions associated with this input proxy address, the instructions defining a manner in which mailpieces are to be delivered to a physical address associated with the input proxy address, and storing the proxy address and associated mail handling instructions in a list of proxy addresses and mail handling instructions.

In yet another aspect of the invention, a method of creating, changing, updating and maintaining proxy addresses for use with postal mailpieces is provided. The method comprises inputting a proxy address, inputting a recipient postal address associated with the input proxy address, and storing the proxy address and associated recipient postal address in a list of proxy addresses and associated recipient postal addresses.

In a further aspect of the invention, a method of providing value-added services for a mailpiece is provided. The method comprises detecting the proxy address on the postal mailpiece, using the detected proxy address to obtain a recipient value-added service from a list of recipient value-added services and associated recipient proxy addresses, and tracking a delivery of the mailpiece to provide the obtained value-added service.

In another aspect, the system for delivering a postal mailpiece is provided. The system comprises a computer readable storage medium and a first database interface computer. The storage medium comprises a database of proxy addresses and associated recipient postal addresses, the addresses within the database being defined by postal recipients associated with the addresses. The first database interface computer is coupled to the storage medium by a communication medium. The first database interface computer inputs a proxy address obtained from the postal mailpiece, accesses the database with the input proxy address to obtain an associated recipient postal address, wherein the postal mailpiece is subsequently delivered to the physical address associated with said obtained recipient postal address.

In a further aspect of the invention, a system for creating a proxy address for a postal mailpiece is provided. The system comprises means for inputting the proxy address, means for inputting a recipient postal address associated with the input proxy address, and means for storing the proxy address and associated recipient postal address in a database of proxy addresses and associated recipient postal addresses.

In a further aspect of the invention, a system for identifying a recipient postal address from a postal mailpiece is provided. The system comprises means for detecting the proxy address on the postal mailpiece and means for using the detected proxy address to obtain a recipient postal address from a list of recipient postal addresses and associated recipient proxy addresses, wherein proxy addresses contained within the list are defined by postal recipients associated with the proxy addresses.

In another aspect of the invention, a system for managing a delivery of a mailpiece is provided. The system comprises means for inputting a proxy address, means for inputting a mail handling instruction associated with this input proxy address, the instruction defining a manner in which mailpieces are to be delivered to a physical address associated with the input proxy address, and means for storing the proxy address and associated mail handling instruction in a list of proxy addresses and mail handling instructions.

In yet a further aspect of the invention, a system for providing value-added services for a mailpiece is provided. The system comprises means for detecting the proxy address on the postal mailpiece, means for using the detected proxy address to obtain a recipient value-added service from a list of recipient value-added services and associated recipient proxy addresses, and means for tracking a delivery of the mailpiece to provide the obtained value-added service.

In another aspect of the invention, an article of manufacture is provided. The article comprises a machine-readable storage medium having stored therein indicia of a plurality of machine-executable control program steps. The control program comprises the steps of detecting a proxy address on a postal mailpiece, using the detected proxy address to obtain a recipient postal address from a list of recipient postal addresses and associated recipient proxy addresses, and delivering the mailpiece to a physical address corresponding to the obtained recipient postal address, wherein proxy addresses contained within the list are defined by postal recipients associated with the proxy addresses.

In a further aspect of the invention another article of manufacture is provided. The article comprises a machine-readable storage medium having stored therein indicia of a plurality of machine-executable control program steps. The control program comprises the steps of detecting a proxy address on a postal mailpiece, using the detected proxy address to obtain a recipient postal address from a database of recipient postal addresses and associated recipient proxy addresses, the addresses within the database being defined by postal recipients associated with the addresses, and affixing the obtained recipient postal address to the postal mailpiece so that the mailpiece can be delivered to a physical address corresponding to the obtained recipient postal address.

In yet a further aspect of the invention, another article of manufacture is provided. The article comprises a machine-readable storage medium having stored therein indicia of a plurality of machine-executable control program steps. The control program comprises inputting a proxy address, inputting a recipient postal address associated with the input proxy address, and storing the proxy address and associated recipient postal address in a list of proxy addresses and associated recipient postal addresses.

In a further aspect of the invention, another article of manufacture is provided. The article comprises a machine-readable storage medium having stored therein indicia of a plurality of machine-executable control program steps. The control program comprises detecting the proxy address on the postal mailpiece and using the detected proxy address to obtain a recipient postal address from a list of recipient postal addresses and associated recipient proxy addresses, wherein proxy addresses contained within the list are defined by postal recipients associated with the proxy addresses.

In another aspect of the invention, another article of manufacture is provided. The article comprises a machine-readable storage medium having stored therein indicia of a plurality of machine-executable control program steps. The control program comprises inputting a proxy address, inputting a mail handling instruction associated with this input proxy address, the instruction defining a manner in which mailpieces are to be delivered to a physical address associated with the input proxy address, and storing the proxy address and associated mail handling instruction in a list of proxy addresses and mail handling instructions.

In a further aspect of the invention, another article of manufacture is provided. The article comprises a machine-readable storage medium having stored therein indicia of a plurality of machine-executable control program steps. The control program comprises detecting the proxy address on the postal mailpiece, using the detected proxy address to obtain a recipient value-added service from a list of recipient value-added services and associated recipient proxy addresses, and tracking a delivery of the mailpiece to provide the obtained value-added service.

It is an object of the invention to provide a method of delivering a postal address using a registration based mail-addressing system.

It is an object of the invention to provide a system and article of manufacture for delivering a postal mailpiece using a registration based mail-addressing protocol.

It is a further object of the invention to allow a postal mailpiece to be addressed with a recipient proxy address.

It is a further object of the invention to deliver a postal mailpiece that contains a recipient proxy address to the correct recipient physical location.

It is a further object of the invention to deliver a mailpiece to a physical location without disclosing the recipient's physical location to the sender.

It is yet a further object of the invention to allow a recipient to customize or personalize its proxy address.

It is a further object of the invention to provide a method of creating and maintaining a proxy address for use on a postal mailpiece.

It is a further object of the invention to provide a system and article of manufacture for creating and maintaining a proxy address for use on a postal mailpiece.

Other objects, features and advantages of the present invention will become apparent from the following detailed description and drawings of preferred embodiments of the present invention.

### BRIEF DESCRIPTION OF THE DRAWINGS

FIG. 1 is an illustration of a typical postal mailpiece.

FIG. 2 is an illustration of a postal mailpiece containing a proxy address in accordance with an embodiment of the invention.

FIG. 3 is an exemplary database used to correlate recipient proxy addresses to recipient names and postal addresses.

FIG. 4 is a flowchart illustrating an exemplary method of delivering a postal mailpiece containing a proxy address.

FIG. 5 is a block diagram illustrating an exemplary system for implementing the registration based mail-addressing system and method of the present invention.

### DETAILED DESCRIPTION OF PREFERRED EMBODIMENTS

The invention establishes a registration based mail-addressing system that allows a recipient to create a proxy address that can be used by senders to send mailpieces to the recipient. As will become apparent, the proxy address allows mailpieces to be delivered to the recipient without the sender knowing the recipient's postal address or physical location. The proxy address adds a new level to the typical postal addressing scheme. As noted earlier, the typical addressing scheme contains two levels. The first level is the physical address and the second level is a multi-field postal address that is difficult to remember, non-intuitive and suffers from several other drawbacks. Using the invention, a new level is established in which a proxy address correlates to an identified recipient postal address.

As described above, postal addresses suffer from numerous limitations due to, for example, format complexity, the number of data fields, the fixed relationship between each postal address and a corresponding physical address, and an inability to be personalized or customized to reflect recipient needs. The present invention introduces proxy addresses, which allow a dynamic relationship between mail recipients and postal addresses, providing ease of use, flexibility and the potential to provide value added services.

Proxy addresses, as embodied within the invention's registration-based mail-addressing system, provide a more powerful, easier to use addressing regime than traditional postal addresses. Each unique proxy address relates to a mailpiece recipient. Mailpiece recipients may be individuals, businesses or institutions. In defining a proxy address, the registrant associates a postal address that satisfies the requirements of mail handling entities and allows delivery of mail pieces to a physical location. As will be described below in more detail, a proxy address system comprises elements including a recognizable format or presentation protocol, a system able to recognize the presence of said format or presentation protocol, a database relating individual proxy addresses to postal addresses, a means of comparing recognized proxy addresses upon mailpieces to proxy addresses within a database, a means to retrieve correct postal addresses relating to a given proxy address, and a means to affect proper delivery of such a mailpiece.

A proxy address may be manifest in any one of a multitude of potential formats or presentation protocols (a non-exhaustive exemplary list is provided hereafter), and it is expected, but not required, that the format will provide for a simple presentation of data (i.e., a one-line or two-line proxy address format may be used by the invention). Moreover, the recipient can customize and personalize the proxy address so that it better reflects the personal or business interests of the recipient (as opposed to a physical location of the recipient). The proxy address does not include a physical address and thus, does not change if the recipient relocates. The proxy address may be easy to remember or identify because it may be composed of mnemonics or intuitive elements that identify the recipient. Moreover, the proxy address is a more useful tool for managing mail flow because the recipient never has to change it, even if she relocates frequently. Instead, a recipient will simply modify the relationship between a proxy address and the correct postal address. Since the proxy address may only contain one-line of information, it substantially reduces the chances for errors when the sender places the address on the mailpiece.

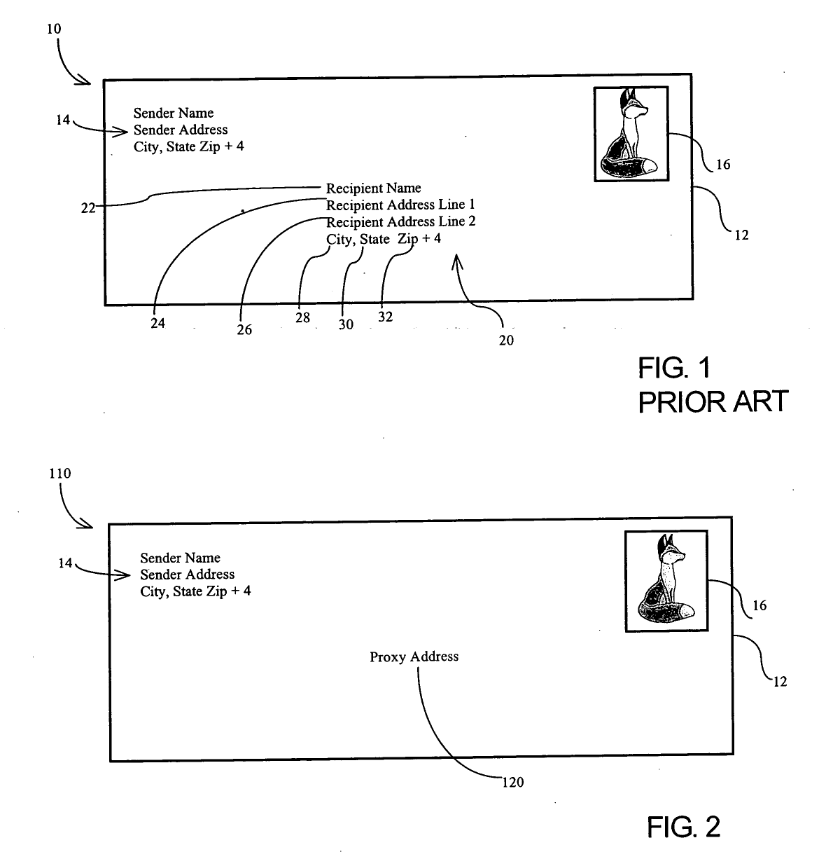

FIG. 2 illustrates a postal mailpiece 110 containing an exemplary proxy address 120 in accordance with an embodiment of the invention. As noted above, the proxy address 120 replaces the multi-field, multi-line recipient postal address 20 (FIG. 1) of the conventional mail-addressing scheme. The mailpiece 110, which in the illustrated embodiment is an envelope 12, also contains a sender/return postal address 14 and a postage marking 16. It should be noted that the mailpiece 110 is not limited to envelopes and that the mailpiece 110 may be a postcard, flat, periodical, package, box, or any other parcel suitable for delivery by the USPS, or any other private or public mail handling entity. It should be noted that the postal marking 16 is not limited to a stamp, but may be any postal marking acceptable to mail handling entities including, but not limited to, a postage meter marking, pre-paid postage marking or franking marking.

One key feature of the proxy address 120 utilized by the invention is that the recipient creates, modifies and updates the proxy address 120 and the relationship between each proxy address and corresponding postal address. As an example of the added functionality provided by the invention, a recipient can establish separate proxy addresses 120 for her home postal address and work postal address and other postal addresses, if desired. The recipient never has to change her proxy address 120 (or addresses) and thus, never has to give out a new proxy address 120 when she moves or gets a new job.

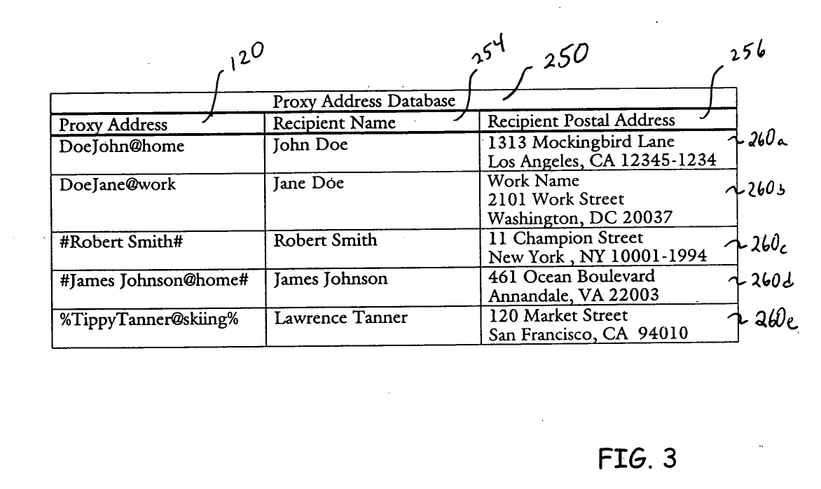

FIG. 3 illustrates several data fields in an exemplary proxy address database 250 used to correlate recipient proxy addresses 120 to recipient names and postal addresses. The database 250 includes a table of identifiers for the recipient proxy address 120, recipient name 254 and recipient postal address 256. The illustrated proxy address database 250 includes a number of example entries 260a, 260b, 260c, 260d, 260e (collectively referred to herein as “entries 260”). It should be appreciated that the exemplary data fields illustrated in FIG. 3 are by no means a complete list of potential database fields, but are provided for illustrative purposes.

In one embodiment of the invention, the entries 260 are created and managed by recipients through an interface to a database 250 owned and managed by a database management/registration organization. Although recipients can manage the entries 260, the organization is responsible for registering the recipients and ensuring that only registered recipients access the database 250. Other responsibilities of the database management organization may include removing unused or expired entries 260, ensuring that all postal address entries meet the mandated address format and content guidelines required by applicable mail handling entities, and preventing objectionable or duplicate entries 260 from being registered in the database 250.

In one embodiment of the invention, a software program may ensure that any proxy address 120 entered into the database 250 adheres to the predefined addressing rules of the present invention. A specific addressing protocol must be established in order for the proxy addresses 120 to be recognized as such by mail handling entities (e.g., USPS, Federal Express, corporate mail department). The addressing protocol of one potential embodiment of the present invention requires that the proxy address 120 include an identifier (e.g. leading keyword or symbol) that alerts the mail handling entities that the database 250 must be queried to obtain the postal address of the intended recipient. As another example of potential proxy address protocols the identifier may be a leading and/or trailing character or symbol, such as e.g., #, %, $, &, or other available symbols. The identifier may also be a presentation format, such as e.g., RecipientName@Home.com.

The protocol also establishes that each proxy address 120 contains a code or sequence of alphanumeric characters that allows it to be uniquely defined. The first entry 260a, for example illustrates “DoeJohn@home” as a proxy address 120 for the recipient John Doe. This exemplary proxy address 120 contains the designation “home” to signify that the address is a home address. The second entry 260b, includes the designation “work” to reflect that the proxy address is a work/office address. Although not required by the addressing protocol of the invention, designations such as “home,” “work,” “office” or other mnemonics and/or intuitive language would help the sender identify and remember the purpose of proxy address 120 and the destination of mailpieces so addressed. The first entry 260a also includes a recipient postal address 256 that will contain all of the information necessary for the mail handling entity to deliver a mailpiece 120 (FIG. 2) to John Doe's home.

The remaining example entries 260 in the database 250 reflect a non-exhaustive listing of proxy address formats and/or protocols 120. Some of the entries 260 (e.g., entry 260a, 260b, 260e) are similar to the electronic mail (e-mail) address format used to send e-mail via computers. Due to increased adoption and use of e-mail, a proxy address 120 that is the same as, or similar to, a recipient's e-mail address could be used by the invention. By using the same address, messages can easily be addressed to an intended recipient for delivery via either postal mail or electronic mail. It should be noted that these entries 260 are mere examples and that the invention is not limited to the specific entries 260 or their format illustrated in FIG. 3. All that is required to practice the invention is a predetermined protocol (i.e., set of rules) for the proxy addresses 120 and a method of ensuring that the proxy addresses 120 adhere to the protocol. As noted earlier, a database management/registration organization would most likely perform these functions.

In addition to information relating proxy addresses to postal addresses, the database 250 may include various entries that enhance system functionality. For example, the database 250 may contain entries that provide detailed mail handling instructions. To accomplish such, the database 250 can include instructions for mail forwarding, temporary hold of mailpieces 10, and routing mailpieces 10 between physical locations. A “timeout” and/or “limited-use” feature can also be implemented using the present invention. That is, there can be an entry 260 in the database 250 that alerts the mail handling entity that mailpieces should not be delivered to this address after a certain date (e.g., the proxy address 120 is no longer valid). By adding to or modifying the database 250 to associate delivery dates with specific recipient postal addresses, recipients can accurately direct mail to a proper location. Because all of this information appears in the database 250, the instructions can be implemented without filing papers with the mail handling entity and without informing the sender. Thus, the mail handling instructions can be implemented in an efficient and easy manner.

Additional data entries may also indicate that a recipient desires to track received mail in an easy and efficient manner. The tracking of mail could be useful when implementing a pre-paid postage system or other value added service. The tracking of mail based on a recipient could also be used to analyze the recipient's mail flow.

For example, the database 250 may incorporate any or all of the following elements depending upon the application desired. To provide pre-paid postage functionality, the database 250 may include the following exemplary information for each proxy address 120: mail handling entity account/meter number information as necessary for correct posting of postage payments and for use in cancellation marking and tracking; current postage credit amount; historical data regarding postage amounts and usage.

To provide mail hold functionality, the database 250 may include the following exemplary information for each proxy address 120: date information for commencement and conclusion of mail hold period; historical data regarding mail hold requests. Further, in order to provide information regarding alternative postal addresses, the database 250 may include the following exemplary information for each proxy address 120: multiple fields containing registrant defined alternative postal addresses; and date fields describing scheduled commencement and termination for usage of alternative postal addresses.

To provide information regarding temporary proxy addresses 120, the database 250 may include the following exemplary information for some proxy addresses 120: a data field identifying the temporary status of a proxy address; data regarding number of times database queries may relate a temporary proxy address to a postal address; data regarding the number of times a database query has related a temporary proxy address to a postal address; expiration data for temporary proxy addresses; and instructions regarding mail handling at conclusion of a temporary proxy address duration.

Moreover, to provide additional information regarding proxy address recipients, the database 250 may include the following information for each proxy address 120: data fields containing phone number, fax number, web address, e-mail address, biographical or business data. It should be appreciated that many recipients will desire to keep information entered into the database 250 confidential, therefore various fields within the database will be provided to designate which information will be available for public viewing, searches or disclosure.

It should be appreciated that these are just some examples of the numerous possibilities that exist for the database 250 and the services that can be provided by the present invention.

Referring now to FIGS. 2-4, an exemplary method 200 of delivering a postal mailpiece 110 containing a proxy address 120 is now described. The method 200 uses a proxy database 250 that has been created and maintained in accordance with a predefined registration based mail-addressing protocol of the invention. The method 200 may be performed manually by mail handling personnel, automatically with use of mailpiece handling computerized equipment, or a combination of manual and automatic steps. If any portion of the method 200 is performed automatically by computerized equipment, then the method 200 could be implemented in software, and both the method 200 and database 250 could be stored on a computer readable storage medium, such as a CD-ROM, floppy disk, or a hard drive.

The method 200 begins at step 202 by detecting that a mailpiece 110 includes a proxy address 120 instead of the conventional recipient postal address 20 (FIG. 1). As noted earlier, this step could be performed by mail handling personnel who look at the mailpiece 110 and recognize one of the proxy address identifiers such as e.g., the symbols #, $, %, or &, or recognizes the presentation format of the address 120 such as e.g., “DoeJane@work.” This step could also be performed by the automated mail handling equipment of a mail handling entity (e.g., USPS) that has been programmed to scan in and recognize valid proxy addresses 120.

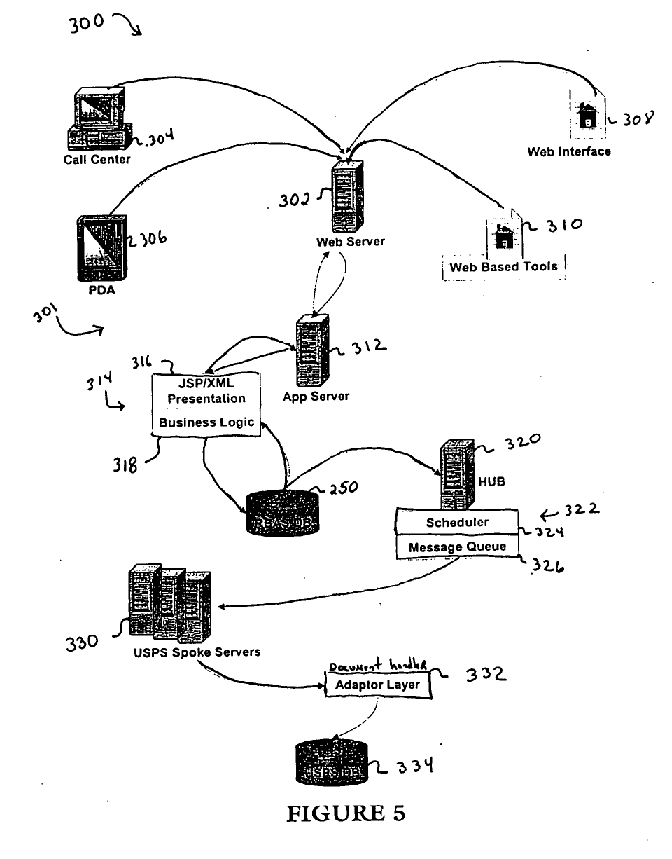

Once a proxy address 120 has been detected, the proxy address 120 is used to access the database 250 to obtain a corresponding recipient postal address (step 204). As will be described below with respect to FIG. 5, the mail handling entity will have access to the database 250 via a computerized communication medium, such as a computer network or the Internet. It is also possible for the mail handling entity to have its own copy of the database 250, if desired, which can be accessed locally without using a network connection. At step 206 the corresponding recipient postal address is obtained from the database 250.

Once the recipient postal address is obtained, it is placed on to the mailpiece 110 so that it may be properly delivered to the intended recipient (step 208). It should be noted that the obtained recipient postal address might be affixed to the mailpiece in human readable form (i.e., text), computer readable form (i.e., barcode), or a combination of human and computer readable form. Current mail handling systems place bar codes on each mailpiece 110 such that sorting equipment can sort them for subsequent delivery and thus, it may be desirable to have both computer readable and human readable information on the mailpiece 110 to identify the recipient postal address. It should be noted, however, that the manner by which the obtained recipient postal address is affixed to the mailpiece and the format used is not important so long as the mail handling entity can deliver the mailpiece 110 to the recipient. Moreover, if the mail handling entity can deliver the mailpiece 110 without affixing the obtained recipient postal address to the mailpiece 110, then step 208 is not required.

At step 210 the mailpiece 110 is delivered to the recipient at the physical address associated with the postal address obtained from the database 250. Thus, the mailpiece 110 is delivered to the recipient while the sender used only a proxy address 120. In doing so, the mailpiece 110 was delivered to the recipient without the sender knowing the recipient's physical location. Moreover, since the proxy address 120 is designed to be easily remembered and transcribed onto the mailpiece 110, the likelihood that the sender was inconvenienced or made an error during the postal process is substantially reduced. Moreover, since the proxy address 120 does not include a postal address, it does not have to change if the recipient relocates.

Referring to FIG. 5, an exemplary embodiment of a system 300 for implementing the present invention is now described. The system 300 includes a web server 302, an applications server 312, a database server 320, user interface 308 for user registration, messaging system 322 for data synchronization, software interface enabling data transfer with mail handling entities, and management and reporting tools 310. The system elements may reside on one or many computers either in whole or in part. However, the exemplary system 300 illustrated and now described comprises multiple hardware and software elements connected via a communications medium such as a computer network (e.g., wide area network, Internet).

In the exemplary embodiment, a proxy address registration and management subsystem 301 is composed of web servers 302, applications servers 312, database servers 320, and associated software including a user interface. The system 300 is designed to be multi-tiered. User requests will be routed through web servers (e.g., server 302), then through application servers (e.g., server 312) to the database server 320. An embedded application 314 consisting of a presentation layer 316 and business logic 318 communicates with the database management subsystem (DBMS) 301 through a standard Java database connectivity (JDBC) layer. The presentation layer 316 may be implemented utilizing JavaServer Pages and XML to allow consistent and efficient data across devices. In an exemplary system embodiment, the web and application servers 302, 312 could be Sun Microsystems Enterprise Server 4500 machines and the database server 320 could be a Sun Microsystems Enterprise Server 10000 machine, each running under the Solaris 7.0 Operating Environment. Exemplary server applications for the web servers 302 and application servers 312 may be Apache HTTP web server and Bluestone Total E Server respectively. In addition, an Oracle database management system could be utilized for database functionality in the exemplary embodiment now described. Such an embodiment would allow heavy utilization of the registration system 301 and provide compatible operability with other system elements.

In another exemplary embodiment, the primary database 250 will comprise a table of identifiers for the recipient proxy address, recipient name, postal address, username, password and other data fields as deemed necessary for functionality and robust operation. To facilitate delta data loads, any additions or modifications will be time stamped and checked against effective date for this purpose. The primary function of the primary proxy address database 250 is to store the relationships between proxy addresses and postal addresses and allow mail recipients to actively manage that information.

Exemplary properties of the proxy address user interface 308 include: proxy registration in accordance with system guidelines and prevention of duplicate registrations, secure registration accomplished through username/password protection, or other protection, of all entries, and flexibility to define proxy address-postal address relationships as fits the needs of system users.

In one exemplary embodiment, access to the user registration and management subsystem 301 is via a web interface 308, web-based tools 310, call center operations 304, or other information device such as a wireless phone or personal digital assistant (PDA) 306.

An exemplary illustration of a typical user interface operation now follows. Upon entering the system 300 via a web page, users (e.g., mail recipients) will be able to register with the system 300 by providing a name, username and password. Afterwards, they will be allowed to enter a proposed proxy address. Once the user-entered proxy address has been validated with persistent store, the user will be able to create a link between the proxy address and a validated postal address. The proxy address and postal address can then be stored in the proxy address database 250.

In an exemplary embodiment of the system 300, data from the primary proxy address database 250 is distributed to locally stored proxy address databases (e.g., database 334) at the individual mail handling sites. This allows rapid processing without risk of delay caused by far reaching communications systems. The messaging system 322 accomplishes necessary distribution and synchronization between the primary proxy address database 250 and a distributed database 334 utilized by automatic mail handling equipment of mail handling entities. The messaging system 322 can best be described as a hub/spoke relationship. A hub is typically a central point that distributes data over a wide range of remote clients, which may have disparate transfer protocol and data format requirements. The hub acts as the dispatcher and is responsible for proper data formatting and transfer protocol. The receivers, or spokes, are responsible for remaining available to receive data and for providing data handlers to process received information. In this exemplary embodiment, the hub is a software layer residing on the database server 320 and the spokes are software layers residing on spoke servers 330 at the mail handling entities.

An exemplary embodiment of the messaging system 322 is comprised of a scheduler 324 and a message queue 326. The scheduler 322 may be used to configure the moments in time when data retrieval from the primary proxy address database 250 is performed. The data retrieval is used for synchronizing the proxy address database 250 with local databases (e.g., database 334) used by mail handling entities. At the scheduled time, the scheduler 322 will call for the retrieval of data that has been created or altered since the time of the last synchronization, create a batched data file for distribution, and transmit the data file into the message queue 326. It will be appreciated that the exemplary embodiment provides for the distribution of a delta file, meaning that only data that has been changed will be transmitted. It is also contemplated that the scheduler 324 will initiate data distribution on a frequent periodic basis (e.g. daily, hourly) during a non-peak time for the systems of recipient mail handling entities.

Once data has been received from the scheduler 324, the message queue 326 is responsible for guaranteeing delivery of the data file to mail handling entity databases 334. If the recipient spoke servers (e.g., servers 330) are down, the message queue 326 will attempt delivery until the file is delivered or the queue times out. Queue time out will cause an error message and e-mail/pager notification to a system administrator. If synchronization is based only on changed data, it is important that the subsystem 301 and local systems be synchronized at every cycle. Data transfer may be performed by secure means; an example embodiment may utilize the HTTPS or public/private key protocols.

In another exemplary embodiment, transfer of data between the subsystem 301 and the distributed servers 330 of mail handling entities will occur via a systems interface that will allow transfer of data without systems integration. In order to accomplish this objective, two intervening layers are necessary—the spoke server software and an adapter layer implemented as a document handler 332.

In the exemplary embodiment, spoke (i.e. recipient) software listens and receives the data files and passes them on to the document handler 332. The spoke software is a communication layer between the subsystem 301 and the automation systems of mail handling entities. This software layer is implemented as an asynchronous, continually running process that activates the document handler 332 after it has received a data synchronization file. The spoke software may reside on a dedicated machine or be a part of the resident database servers 330 of mail handling entities.

The adapter layer/document handler 332 may be responsible for parsing the data file and translating it into the proper form for the mail handling entity database 334. In addition to providing data translation functionality, the document handler 332 will affect the load of data into the mail-handling database 334 and log success/failure along with number of records added or modified. Updates should be guarded in commit/rollback blocks to preserve data integrity. The system 300, as structured in this exemplary embodiment, can support a variety of database implementation scenarios at mail handling entity sites. A non-exhaustive list of implementation scenarios includes: a dedicated proxy address database residing on a local computer and integration of proxy address information into existing database structures. It will be appreciated that details of database implementation at postal processing sites will vary according to the process and hardware extant at those processing sites.

In an exemplary embodiment of the system 300 it is assumed that a postal processing site is equipped with optical character recognition (OCR) or other image capture equipment that lifts address images from mail pieces, and such other equipment or personnel necessary to translate physical address information into an electronic format recognized by the mail processing system. Through use of mandated proxy address identifiers or a mandated presentational format, mail-handling entities will identify those addresses that conform to proxy address standards. Once recognized and transformed to an electronic form, the proxy address is compared to a locally stored copy of the proxy address database 250 that contains proxy address information and corresponding postal addresses. In an exemplary embodiment using an SQL query structure and the exemplary database 250 illustrated in FIG. 3, a database query would take the form: SELECT RECIPIENT NAME, RECIPIENT POSTAL ADDRESS FROM PROXYADDRESSDATABASE WHERE PROXYADDRESS=‘DoeJane@Work’. The exemplary query result would then be: ‘Jane Doe’ ‘WORK NAME 2101 WORK STREET WASHINGTON DC 20037.’ Upon successful resolution of the database query, the postal processing equipment could then utilize automated labeling equipment or in-line printers to apply the retrieved postal address information to the mail piece. After the postal address has been printed on or affixed to a mail piece, delivery is accomplished through established practice.

Data management and reporting tools 310 with a management interface will be necessary to configure, and maintain the system 300. In an exemplary embodiment, the data management interface would allow the administrator to configure the scheduler, start/stop the hub, rollout new functionality, and provide metrics within regarding the system 300. Additional tools would provide functionality to add, edit and view user proxy addresses.

It should be noted that the present invention could be used world-wide as a new form of delivering mail throughout the United States and Internationally in public, private and corporate mailing environments. Since the invention is easily accessible from the Internet, recipients throughout the world can register and gain access to the proxy address database 250.

Moreover, the invention offers methods of doing business for the database management/registration organization. For example, the organization can market and sell the invention as an internal mailing system for a corporation, law firm, organization, or other entity. The invention can be sold as a software application to the organization, which allows the organization to set up its own proxy address database for its employees and/or customers. Employees could send mailpieces to other employees, customers, clients, vendors, or other entities using a proxy address. The organization's mail room would access the organization's proxy address database (or a world-wide database if authorized) to obtain the recipient postal address, place postage on the mailpiece and then cause the mailpiece to be delivered (e.g., via USPS). The invention would be extremely suitable for organizations that have many offices, clients, vendors, or other entities spread throughout the world.

The present invention could be used by some organizations to externalize their internal mail handling as well. The organization can set up proxy addresses, use the proxy addresses on its outgoing mailpieces and deposit them in a public mail system rather than utilize an expensive and cumbersome internal mail system.

The present invention is useful to both individuals and businesses for a multitude of purposes, too numerous to list. The present invention could be used for advertising and marketing purposes. That is, a proxy address 120 is a powerful brand management tool, reinforcing the identity and name of a company or product at a broader array or customer interactions. For example, a company may register the trade name of a popular brand or product, thereby facilitating increased mail communication from consumers. By advertising the proxy address 120, the company further publicizes the brand or product name improving consumer awareness and perception.

In addition, the invention is useful for response marketing. Marketing campaigns that require a specific consumer action in order to be effective will benefit from proxy addresses 120 and the present invention through increased customer response. A television advertisement encouraging viewers to write to “AAA Computer Training” for information on computer training classes will have a higher response rate than an advertisement requiring the usage of lengthy and complex postal address.

Moreover, customer service can benefit from the invention. Customer initiated interactions will be facilitated through the use of the present invention. Customer comments, complaints and thanks can be easily sent using the key elements of a product or company name. For example: “Painless Dentistry Complaints.” Contests, campaigns and fund raising can benefit from the invention as well. Proxy addresses 120 provide an easily managed, flexible address for entities with changing needs and sudden increases in mail usage. A political campaign may be able to accept thousands of mailed donations at out sourced processing facilities during peak fundraising months, and then route mail to campaign offices during less intensive times. Another example of the particular utility to fundraising entities is illustrated by potentially higher response rates to radio fund drives if pledge monies can be mailed to the station call letters (e.g. KQED Fund Drive) instead of a complex postal address.

Image management can be fostered by the invention. Large institutions with a presence in primary business markets seek to maintain a prestigious image. However, many customer-response and back-office functions may be based in less-prestigious business areas. Use of a proxy address 120 identifying the company and the customer service function (as opposed to its physical location) will allow incoming mail to flow to processing centers without disclosing their location to brand-conscious customers.

Mail flow management will also benefit from the invention. Businesses can easily re-direct mail flows to attain higher levels of efficiency without bearing the expense and difficulty of reprinting product and company literature. A single address management action may cause customer service mail relating to a rapidly growing product line to be re-directed from a general response facility in one location to a specialized resource in another location. In addition, businesses may choose to provide proxy addresses 120 to key customers to reduce the toll of lost or misdirected correspondence. For example, many credit card issuers focus on college students, who move frequently. By providing students/customers an easily managed proxy address 120, the risk of lost or misdirected mail sent to frequently moving students would be reduced.

In addition to straightforward postal address management and simplified mail-addressing, potential embodiments of the present invention can provide numerous value-added services. For example, database management organization will verify that all postal addresses in the proxy address database comply with the addressing standards of relevant mail handling entities. Such verification includes certification of address existence and addressing format in addition to steps necessary to allow mailpiece bar coding and subsequent efficient automated handling.

Proxy address recipients can provide pre-paid postage for mail sent to a proxy address 120. Address recipients would pre-pay postage through the database management organization, creating a postage credit to be recorded in a secured database field of the proxy address database 250. When automated handling equipment determines that a mailpiece bears a valid proxy address and further determines that the mailpiece does not have a postage marking, the system will query the proxy address database 250 to determine the availability of sufficient postage credit for delivery of the mailpiece. If sufficient credit exists, the mailpiece postage area is cancelled (post marked) and the postage credit is debited an appropriate amount.

As noted above, the invention can be used for temporary mail holding. As a portion of the database management functionality, proxy address recipients will have user interface functionality that allows them to specify a “mail hold” period relative to a particular proxy address. Such information would direct mail carriers to hold mail in the same way existing mail hold services are provided. Similarly, temporary mail forwarding capabilities can also be achieved with the invention. Proxy address recipients may modify corresponding postal addresses permanently, or on a temporary basis. For example, by allowing proxy address recipients to record an expiration date or scheduled modifications for a modified proxy address/postal address relationship.

As noted above, some individuals or businesses may wish to keep address information confidential, while others may wish to allow members of the public to search database contents to allow determination of proxy addresses, postal addresses or other information. Information access rules can be established at the time of proxy address registration and modified from time to time by recipients. Moreover, the invention allows the use of temporary addresses. Proxy address recipients may have the option of stating the number of times an address may be used, or the period of time it is valid. Once the established delivery conditions are no longer satisfied, queries of the proxy address database 250 will result in a “Return to Sender” instruction for postal processing. The invention can be used for address convergence. That is, proxy addresses 120 that reflect, or are the same as, other information addresses may be of value to some individuals and companies. For example, a company may wish to establish a proxy address 120, e-mail address and toll-free phone number for a new product or service introduction.

It should be noted that information regarding proxy addresses 120 may be collected, registered and managed through the use of various methods including: input by computers, through the use of computer networks (Internet/intranet), via automated telephone entry using keypad or voice input, via inbound telephone call center operations, via outbound telephone call center operations, via US Mail or other mail handling entity, through direct employed sales personnel, via retail POS (point of sale), trade show, or entertainment partners/registrars. Automated generation of proxy addresses 120 through computer networks based on third party registrations or data collection methods may also be utilized.

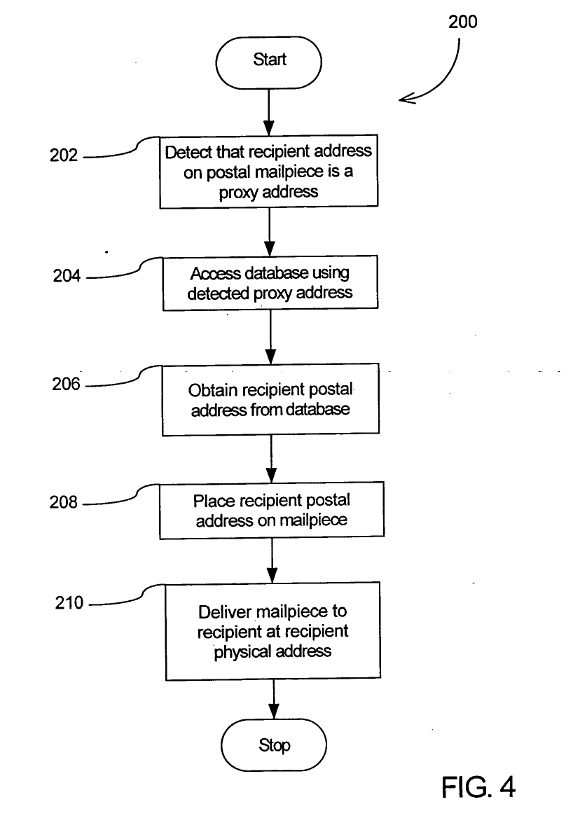

While the invention has been described in detail in connection with preferred embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, the individual method steps of the exemplary operational flow illustrated in FIG. 4 may be interchanged in order, combined, replaced or even added to without departing from the scope of the invention. Any number of different operations not illustrated herein may be performed utilizing the invention.

The components described herein such as the components modules making up the system 300 (FIG. 5) may be one or more hardware, software, or hybrid components residing in (or distributed among) one or more local or remote systems. It should be readily apparent that the components may be combined or further separated into a variety of different components, sharing different resources (including processing units, memory, clock devices, and software routines) as required for the particular implementation of the embodiments disclosed herein. Indeed, even a single general purpose computer executing a computer program stored on a recording medium to produce the functionality and any other memory devices referred to herein may be utilized to implement the illustrated embodiments. Interface devices utilized by, in, or in conjunction with the system 300 may be any device used to input and/or output information. The interface devices may be implemented as a graphical user interface (GUI) containing a display or the like, or may be a link to other user input/output devices known in the art.

Furthermore, memory units employed by the system may be any one or more of the known storage devices (e.g., Random Access Memory (RAM), Read Only Memory (ROM), hard disk drive (HDD), floppy drive, zip drive, compact disk-ROM, DVD, and bubble memory), and may also be one or more memory devices embedded within a CPU, or shared with one or more of the other components. Accordingly, the invention is not to be seen as limited by the foregoing description, but is only limited by the scope of the appended claims.

What is claimed as new and desired to be protected by Letters Patent of the United States is:

1-45. (canceled)

46. A method of delivering a postal mailpiece to a recipient postal address which is unique to an addressee, said method comprising the steps of:
detecting a proxy address on the postal mailpiece wherein said proxy address is defined by a set of presentation protocols that distinguish said proxy address from other addresses, and said entire proxy address does not change upon the change of the recipient postal address, wherein said set of presentation protocols comprise mnemonics or intuitive elements that relate to the recipient;
using the detected proxy address to obtain through a database query applying said addressing protocols, the recipient postal address from a database of recipient postal addresses and associated recipient proxy addresses, the addresses within the database being defined by postal recipients associated with the addresses; and
affixing the obtained recipient postal address to the postal mailpiece so that the mailpiece can be delivered to a physical address corresponding to the obtained recipient postal address.

47. The method of claim 46, wherein said addressing protocols comprise mnemonics representing a category in which a related physical address belongs.

48. The method of claim 46, wherein said step of detecting the proxy address comprises detecting a symbol on the postal mailpiece that corresponds to said predefined proxy addressing protocol.

49. A system for delivering a postal mailpiece comprising:
a computer readable storage medium, said storage medium comprising a database of proxy addresses and associated recipient postal addresses, the addresses within the database being defined by postal recipients associated with the addresses and the associated proxy addresses each having the characteristic of not changing in their entirety upon the change of each associated recipient postal address, wherein said proxy addresses comprise mnemonics or intuitive elements that relate to the recipient; and
a first database interface computer coupled to said storage medium by a communication medium, said first database interface computer inputting a proxy address obtained from the postal mailpiece, said first database interface computer accessing said database with said input proxy address to obtain an associated recipient postal address, wherein the postal mailpiece is subsequently delivered to a physical address corresponding to said obtained recipient postal address.

50. The system of claim 49, wherein said first database interface computer affixes said obtained recipient postal address on the postal mailpiece.

51. The system of claim 49, wherein said communication medium is a computer network.

52. The system of claim 49, wherein said communication medium is the Internet.

53. The system of claim 49, further comprising a second database interface computer coupled to said computer readable storage medium by a second communication medium, said second database interface computer providing a means for recipients to modify addresses within said database.

54. The system of claim 53, wherein said second database interface computer allows a recipient associated with a first proxy address and a first recipient postal address to modify the first recipient postal address without modifying the first proxy address.

55. The system of claim 53, wherein said second database interface computer allows a recipient associated with a first proxy address and a first recipient postal address to modify the first proxy address without modifying the first recipient postal address.

56. The system of claim 53, further comprising a third database interface computer coupled to said computer readable storage medium by a third communication medium, said third database interface computer providing a means for recipients to register with said system and become authorized to modify addresses within said database.

57. An article of manufacture comprising a machine-readable storage medium having stored therein indicia of a plurality of machine-executable control program steps, the control program comprising the steps of:
detecting a proxy address on a postal mailpiece, said proxy addresses comprising mnemonics or intuitive elements that relate to the recipient;
using the detected proxy address to obtain a recipient postal address from a list of recipient postal addresses and associated recipient proxy addresses; and
delivering the mailpiece to a physical address corresponding to the obtained recipient postal address, wherein proxy addresses contained within the list are defined by postal recipients associated with the proxy addresses, and wherein an associated proxy address has a characteristic of not changing upon the change of an associated recipient postal address.

58. The article of manufacture of claim 57, wherein the control program further comprises the step of modifying the list of recipient postal and proxy addresses by recipients authorized to modify the list.

59. The article of manufacture of claim 57, wherein said step of detecting the proxy address comprises detecting an identifier on the postal mailpiece that corresponds to a predefined proxy addressing protocol.

60. A method of delivering a postal mailpiece to a recipient postal address which is unique to an addressee, said method comprising the steps of:
detecting a proxy address on the postal mailpiece wherein said proxy address is defined by a set of presentation protocols that distinguish said proxy address from other addresses, and said entire proxy address does not change upon the change of the recipient postal address, wherein said set of presentation protocols are created, modified and updated by the recipient;
using the detected proxy address to obtain through a database query applying said addressing protocols, the recipient postal address from a database of recipient postal addresses and associated recipient proxy addresses, the addresses within the database being defined by postal recipients associated with the addresses; and
affixing the obtained recipient postal address to the postal mailpiece so that the mailpiece can be delivered to a physical address corresponding to the obtained recipient postal address.

61. The method of claim 60, wherein said addressing protocols comprise mnemonics representing a category in which a related physical address belongs.

62. The method of claim 60, wherein said step of detecting the proxy address comprises detecting a symbol on the postal mailpiece that corresponds to said predefined proxy addressing protocol.

63. A system for delivering a postal mailpiece comprising:
a computer readable storage medium, said storage medium comprising a database of proxy addresses and associated recipient postal addresses, the addresses within the database being defined by postal recipients associated with the addresses and the associated proxy addresses each having the characteristic of not changing in their entirety upon the change of each associated recipient postal address, wherein said proxy addresses are created, modified and updated by the recipient; and
a first database interface computer coupled to said storage medium by a communication medium, said first database interface computer inputting a proxy address obtained from the postal mailpiece, said first database interface computer accessing said database with said input proxy address to obtain an associated recipient postal address, wherein the postal mailpiece is subsequently delivered to a physical address corresponding to said obtained recipient postal address.

64. The system of claim 63, wherein said first database interface computer affixes said obtained recipient postal address on the postal mailpiece.

65. The system of claim 63, wherein said communication medium is a computer network.

66. The system of claim 63, wherein said communication medium is the Internet.

67. The system of claim 63, further comprising a second database interface computer coupled to said computer readable storage medium by a second communication medium, said second database interface computer providing a means for recipients to modify addresses within said database.

68. The system of claim 67, wherein said second database interface computer allows a recipient associated with a first proxy address and a first recipient postal address to modify the first recipient postal address without modifying the first proxy address.

69. The system of claim 67, wherein said second database interface computer allows a recipient associated with a first proxy address and a first recipient postal address to modify the first proxy address without modifying the first recipient postal address.

70. The system of claim 67, further comprising a third database interface computer coupled to said computer readable storage medium by a third communication medium, said third database interface computer providing a means for recipients to register with said system and become authorized to modify addresses within said database.

71. A method of delivering a postal mailpiece to a recipient postal address which is unique to an addressee, said method comprising the steps of:
detecting a proxy address on the postal mailpiece wherein said proxy address is defined by a set of presentation protocols that distinguish said proxy address from other addresses, and said entire proxy address does not change upon the change of the recipient postal address, wherein said set of presentation protocols comprise mnemonics or intuitive elements that relate to the recipient and is created, modified and updated by the recipient;
using the detected proxy address to obtain through a database query applying said addressing protocols, the recipient postal address from a database of recipient postal addresses and associated recipient proxy addresses, the addresses within the database being defined by postal recipients associated with the addresses; and
affixing the obtained recipient postal address to the postal mailpiece so that the mailpiece can be delivered to a physical address corresponding to the obtained recipient postal address.

72. A system for delivering a postal mailpiece comprising:
a computer readable storage medium, said storage medium comprising a database of proxy addresses and associated recipient postal addresses, the addresses within the database being defined, created, modified and updated by postal recipients associated with the addresses and the associated proxy addresses each having the characteristic of not changing in their entirety upon the change of each associated recipient postal address, wherein said proxy addresses comprise mnemonics or intuitive elements that relate to the recipient; and
a first database interface computer coupled to said storage medium by a communication medium, said first database interface computer inputting a proxy address obtained from the postal mailpiece, said first database interface computer accessing said database with said input proxy address to obtain an associated recipient postal address, wherein the postal mailpiece is subsequently delivered to a physical address corresponding to said obtained recipient postal address.
